(19) United States
(12) Patent Application Publication
(10) Pub. No.: US 2026/0235820 A1
(43) Pub. Date: Aug. 13, 2026

(54) MAGNETICALLY ATTACHABLE FIBER COUPLER

(71) Applicant: Lightmatter, Inc., Mountain View, CA (US)

(72) Inventors: Sufi Ahmed, Chandler, AZ (US); Omkar Karhade, Chandler, AZ (US); Shashank Gupta, Gurugram (IN)

(73) Assignee: Lightmatter, Inc., Mountain View, CA (US)

(21) Appl. No.: 19/531,395

(22) Filed: Feb. 5, 2026

Related U.S. Application Data
(60) Provisional application No. 63/756,021, filed on Feb. 7, 2025.

(51) Int. Cl. G02B 6/38; G02B 6/42

(52) U.S. Cl. CPC G02B 6/3886; G02B 6/4214; G02B 6/4277; G02B 6/4292

(57) ABSTRACT

A device includes a magnetically attachable fiber array unit (FAU) for coupling optical fibers to a photonic integrated circuit (PIC). The device uses magnetic retention to secure the FAU to a substrate, where the FAU includes a fiber that is optically coupled to a waveguide of the PIC. Conventional fiber array units use mechanical retention means such as latches, clips, spring-loaded ball bearings, or friction fits to achieve pluggability. These mechanical parts can experience wear and tear from repeated insertions and removals. The magnetically attachable fiber coupler provides an alternative to conventional mechanical retention approaches by using magnetic retention for a pluggable FAU that attaches to a package including a PIC. By replacing mechanical retention means with magnetic retention, the magnetically attachable fiber coupler may reduce susceptibility to wear from repeated connection and disconnection cycles.

### CROSS-REFERENCE TO RELATED APPLICATION

This application claims the benefit under 35 U.S.C. § 119(e) of U.S. Provisional Application Ser. No. 63/756,021, filed on Feb. 7, 2025, under Attorney Docket No. L0858.70119US00 and entitled “MAGNETICALLY ATTACHABLE FIBER COUPLER,” which is hereby incorporated herein by reference in its entirety.

### BACKGROUND

Fiber Array Units (FAUs) provide a way to make fiber optic connections pluggable. This allows for easier maintenance, upgrades, and reconfiguration of optical systems. Pluggability offers flexibility and simplifies the process of connecting and disconnecting fiber optic cables from other optical devices, such as photonic integrated circuits (PICs). Conventional FAUs use mechanical retention for pluggability. For example, a small latch or clip, a spring-loaded ball bearing, or a friction fit may be used to secure the fiber optic connector in place.

### SUMMARY

In some aspects, the techniques described herein relate to a device, including: a substrate; a photonic integrated circuit (PIC) disposed on the substrate; and a magnetic bar disposed on the substrate, wherein the magnetic bar is configured to magnetically couple to a magnet of a fiber array unit (FAU).

In some aspects, the techniques described herein relate to a device, further including a socket disposed on the substrate, the socket having a cutout in which the FAU is disposed.

In some aspects, the techniques described herein relate to a device, wherein the socket is formed from a non-magnetic material.

In some aspects, the techniques described herein relate to a device, further including the FAU and a fiber attached to the FAU, wherein the fiber is configured to be optically coupled to a waveguide of the PIC when the magnetic bar is magnetically coupled to the magnet.

In some aspects, the techniques described herein relate to a device, further including a coupler configured to optically couple the waveguide to the fiber.

In some aspects, the techniques described herein relate to a device, wherein the coupler includes a plurality of reflective surfaces configured to guide light between the waveguide and the fiber.

In some aspects, the techniques described herein relate to a device, wherein the coupler further includes a lens configured to focus or collimate light reflected by the plurality of reflective surfaces.

In some aspects, the techniques described herein relate to a device, wherein the FAU includes: a pluggable fiber ferrule holding the fiber; and magnetic shielding encasing the pluggable fiber ferrule, wherein the magnet is attached to the magnetic shielding.

In some aspects, the techniques described herein relate to a device, wherein the magnetic shielding includes copper.

In some aspects, the techniques described herein relate to a device, wherein the magnetic bar is disposed in a trench formed in the substrate.

In some aspects, the techniques described herein relate to a device, further including an adhesive disposed between the magnetic bar and a bottom of the trench.

In some aspects, the techniques described herein relate to a device, including: a substrate; a photonic integrated circuit (PIC) disposed on the substrate, the PIC having a waveguide; and a fiber array unit (FAU) to which a fiber is attached, wherein the FAU is magnetically attached to the substrate, and wherein the fiber is optically coupled to the waveguide of the PIC.

In some aspects, the techniques described herein relate to a device, further including a magnetic bar disposed on the substrate and a magnet attached to the FAU, wherein the magnet is configured to magnetically couple with the magnetic bar to secure the FAU to the substrate.

In some aspects, the techniques described herein relate to a device, wherein the magnetic bar is disposed in a trench formed in the substrate.

In some aspects, the techniques described herein relate to a device, further including an adhesive disposed between the magnetic bar and a bottom of the trench.

In some aspects, the techniques described herein relate to a device, further including a socket disposed on the substrate, the socket having a cutout in which the FAU is disposed, wherein the socket extends over a portion of a coupler that optically couples the waveguide to the fiber.

In some aspects, the techniques described herein relate to a method of manufacturing an optical device, including: providing a substrate having a trench formed therein, wherein a photonic integrated circuit (PIC) is disposed on the substrate; attaching a magnetic bar in the trench; attaching a socket to the substrate, the socket having a cutout configured to receive a fiber array unit (FAU) to which a fiber is attached; and inserting the FAU through the cutout to optically couple the PIC to the fiber, wherein the FAU includes a magnet configured to magnetically couple with the magnetic bar to secure the FAU to the substrate.

In some aspects, the techniques described herein relate to a method, further including dispensing adhesive on the substrate around the magnetic bar prior to attaching the socket.

In some aspects, the techniques described herein relate to a method, further including attaching an integrated heat spreader (IHS) to the substrate such that the IHS contacts a thermal interface material (TIM) disposed on a die positioned above the PIC.

In some aspects, the techniques described herein relate to a method, wherein the FAU includes a pluggable fiber ferrule encased within a magnetic shielding, and wherein the magnet is attached beneath the magnetic shielding.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 illustrates a cross-sectional view of a device including a magnetically attachable fiber array unit, according to aspects of the present disclosure.

FIG. 2 illustrates a side view of an example of a fiber array unit, according to aspects of the present disclosure.

FIG. 3A illustrates a side view of an example of a socket configured to receive a magnetically attachable fiber array unit, according to aspects of the present disclosure.

FIG. 3B illustrates a rear view of the socket of FIG. 3A, according to aspects of the present disclosure.

FIG. 4 illustrates a sectional view of an example of a coupler, according to aspects of the present disclosure.

FIGS. 5A-5F, collectively, illustrate a process for manufacturing a photonic device, according to aspects of the present disclosure. In the step corresponding to FIG. 5A, trenches are formed on a substrate. In the step corresponding to FIG. 5B, magnetic bars are disposed in the trenches. In the step corresponding to FIG. 5C, adhesive is applied to secure the magnetic bars. In the step corresponding to FIG. 5D, a socket is attached to the substrate. In the step corresponding to FIG. 5E, an integrated heat spreader is attached to the substrate. In the step corresponding to FIG. 5F, a fiber array unit is inserted into the socket.

### DETAILED DESCRIPTION

Described herein is a device that includes a magnetically attachable fiber array unit (FAU) for coupling optical fibers to a photonic integrated circuit (PIC). The device may use magnetic retention to secure the FAU to a substrate, where the FAU includes a fiber that is optically coupled to a waveguide of the PIC.

Conventional fiber array units use mechanical retention means to achieve pluggability. These mechanical retention means may include latches, clips, spring-loaded ball bearings, or friction fits that secure a fiber optic connector in place. The inventors have recognized and appreciated that these mechanical parts can experience wear and tear from repeated insertions and removals. Over time, such wear may degrade the reliability of the connection and may require maintenance or replacement of the mechanical components.

Recognizing these limitations, the inventors have developed a magnetically attachable fiber coupler that provides a more robust alternative to conventional mechanical retention approaches. The magnetically attachable fiber coupler may use magnetic retention for a pluggable FAU that attaches to a package including a PIC. By replacing mechanical retention means with magnetic retention, the magnetically attachable fiber coupler may reduce susceptibility to wear from repeated connection and disconnection cycles. The magnetic retention approach may allow for easier maintenance, upgrades, and reconfiguration of optical systems while maintaining reliable attachment between the FAU and the substrate. In some cases, the magnetic retention may provide consistent attachment force over many insertion and removal cycles without the degradation that may occur with mechanical retention mechanisms.

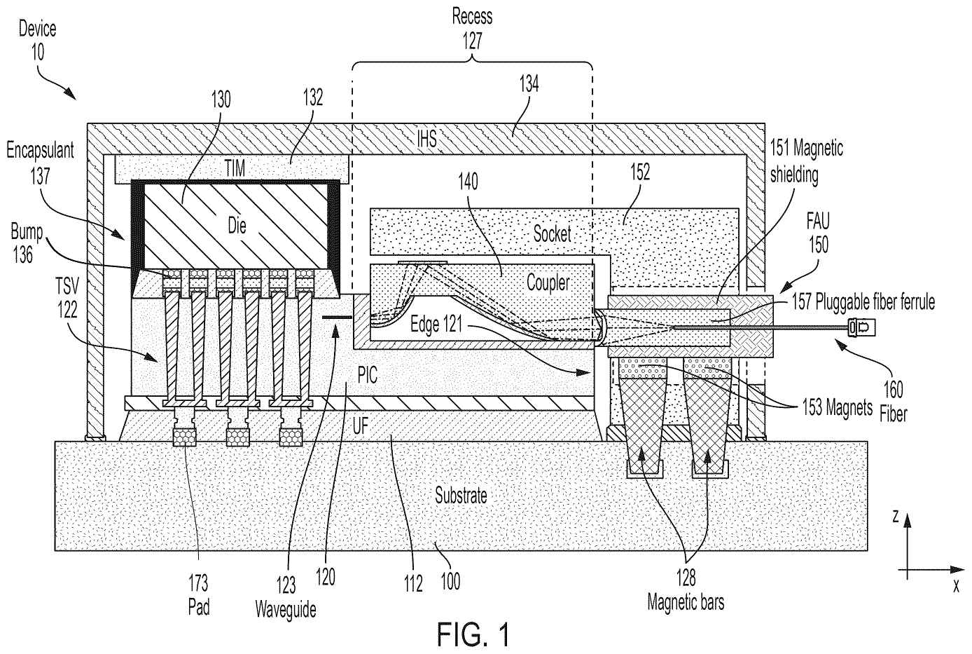

Referring to FIG. 1, a device 10 includes a magnetically attachable fiber array unit (FAU) 150 for coupling optical fibers to a photonic integrated circuit (PIC) 120. The device 10 includes a substrate 100 that serves as a base structure supporting various components of the device 10. Substrate 100 may include a printed circuit board (PCB), an organic support, or an interposer, for example.

The PIC 120 is disposed on the substrate 100 and includes a network of waveguides, including waveguide 123, for guiding optical signals. The PIC 120 may be fabricated using silicon photonics technology, enabling integration of optical components on a silicon substrate. In some embodiments, the PIC 120 may include a silicon-on-insulator (SOI) substrate including a buried oxide layer that provides optical confinement for the waveguides. The PIC 120 may further include various optical components such as modulators, photodetectors, multiplexers, demultiplexers, and other passive or active optical elements integrated within the same substrate. The PIC 120 may include metal layers to facilitate electrical connections and signal routing within the device 10. The metal layers may include multiple metallization levels interconnected by vias, providing electrical pathways between the PIC 120 and other components of the device 10. Pads 173 may be positioned on a lower surface of the PIC 120. The pads 173 may provide electrical connection to the substrate 100. An underfill 112 is disposed on the substrate 100 between the substrate 100 and the PIC 120 to provide structural support and protection for interconnections between the PIC 120 and the substrate 100.

A die 130 is positioned above the PIC 120. The die 130 may comprise an application-specific integrated circuit (ASIC) that is electrically coupled to the PIC 120. The die 130 may include driver circuitry configured to provide electrical signals to modulators within the PIC 120. The die 130 may also include transimpedance amplifiers configured to receive electrical signals from photodetectors within the PIC 120. In some embodiments, the die 130 may include digital signal processing circuitry, serializer/deserializer (SerDes) circuitry, clock and data recovery circuitry, or other electronic components for processing data signals. In some embodiments, the die 130 may comprise a graphics processing unit (GPU), a central processing unit (CPU), a high bandwidth memory (HBM) device, a network switch, a tensor processing unit (TPU), or other high-performance computing components. The die 130 may be fabricated using complementary metal-oxide-semiconductor (CMOS) technology, enabling high-speed electronic processing capabilities. The die 130 may be flip-chip bonded to the PIC 120, with solder bumps 136 or copper pillars providing electrical and mechanical connections between the two chips. Alternatively, the die 130 may be hybrid-bonded to the PIC 120. Through-silicon vias (TSV) 122 extend vertically through a portion of the PIC 120 to provide electrical connections between different layers of the device 10.

An encapsulant 137 surrounds the die 130 and provides protection and structural support for the die 130. The encapsulant 137 may comprise a molded material, such as an epoxy molding compound, that encapsulates the assembly and provides structural support. The encapsulant 137 may be formed using a transfer molding process or other suitable encapsulation techniques. The encapsulant 137 may also provide thermal management by dissipating heat generated by the die 130, PIC 120, and other active components within the device 10.

A thermal interface material (TIM) 132 is disposed on top of the die 130 to facilitate heat transfer away from the die 130. The TIM 132 provides a thermally conductive pathway between the die 130 and an integrated heat spreader (IHS) 134, filling any microscopic gaps or surface irregularities that would otherwise impede heat dissipation. The TIM 132 may comprise a thermally conductive paste, gel, pad, or phase-change material. An integrated heat spreader (IHS) 134 is positioned above the TIM 132 and contacts the TIM 132 to dissipate heat generated by the die 130.

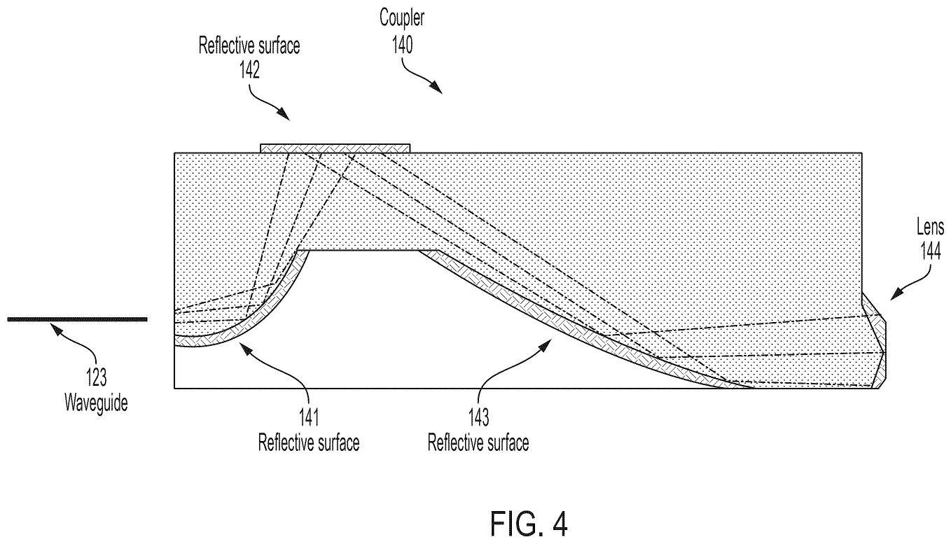

As further shown in FIG. 1, a coupler 140 is integrated with the device 10 and is configured to direct optical signals between the waveguide 123 and external optical components. The coupler 140 may be formed from glass, silicon, or any other material that is transparent to light at the wavelength of interest. The coupler 140 may be fabricated using precision molding, machining, etching, or other suitable manufacturing techniques that enable formation of the optical surfaces and features within the coupler 140. The coupler 140 is positioned in a recess 127 formed on a top surface of the PIC 120, where the recess 127 extends through an outer edge 121 of the PIC 120. This arrangement enables optical coupling between the coupler 140 and the waveguide 123. An example of a coupler is described below with reference to FIG. 4.

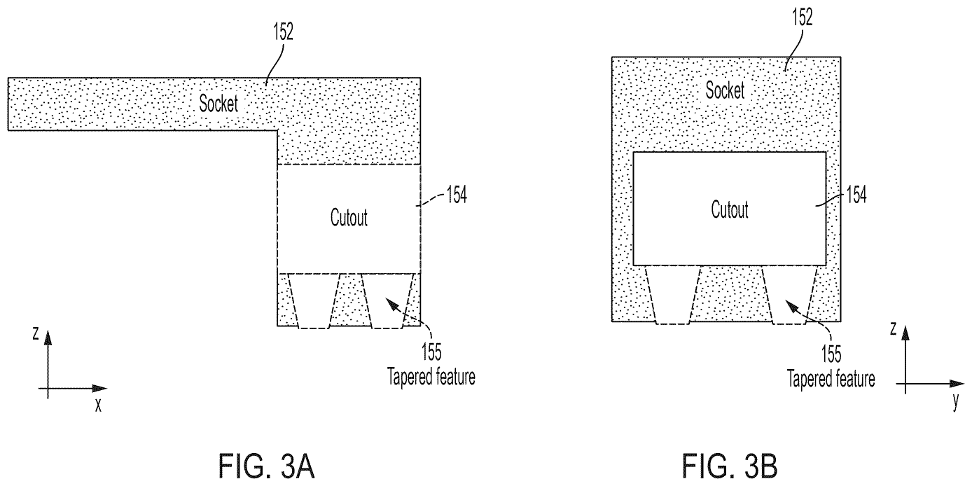

A socket 152 is disposed on the substrate 100 and extends over a portion of the coupler 140 to provide protection for the coupler 140. The socket 152 serves as a structural framework for receiving and positioning an FAU 150 during attachment to the device 10. The socket 152 includes a cutout that provides an opening through which the FAU 150 can be inserted and aligned with the coupler 140 for optical coupling. The socket 152 may be formed from a non-magnetic material to avoid interfering with the magnetic retention mechanism used to secure the FAU 150 to the substrate 100. An example of a socket is described in detail below with reference to FIGS. 3A-3B.

The FAU 150 is a fiber array unit that provides a mechanical structure for holding and aligning one or more optical fibers for coupling to optical components of PIC 120. The FAU 150 is attached to the device 10 through magnetic retention. A fiber 160 is attached to the FAU 150 and extends from the FAU 150 to provide optical connectivity to external systems. The fiber 160 is optically coupled to the waveguide 123 of the PIC 120 through the coupler 140. Magnetic bars 128 are disposed on the substrate 100 and extend vertically to provide magnetic attachment points for the FAU 150. The FAU 150 includes magnets that are configured to magnetically couple with the magnetic bars 128 to secure the FAU 150 to the substrate 100. When the FAU 150 is inserted through the socket 152, the magnets on the FAU 150 interact with the magnetic bars 128 through magnetic attraction, thereby securing the FAU 150 in position on the substrate 100. The magnetic bars 128 also serve to align the FAU 150 during attachment, positioning the fiber 160 for optical coupling with the waveguide 123 of the PIC 120.

The magnetic retention mechanism described herein may be implemented independently of the specific optical coupling approach used to connect the fiber 160 to the waveguide 123. In some embodiments, the coupler 140 may be omitted from the device 10. For example, the magnetic retention provided by the magnetic bars 128 and the magnets 153 on the FAU 150 may enable direct optical coupling between the waveguide 123 and the fiber 160 without an intervening coupler. In such configurations, the fiber 160 may be positioned to edge-couple directly to an end facet of the waveguide 123, where the magnetic retention mechanism maintains alignment between the fiber 160 and the waveguide 123. The magnetic bars 128 may be positioned to align the FAU 150 such that the fiber 160 is brought into close proximity with the waveguide 123 for edge coupling. In some aspects, the waveguide 123 may include a spot-size converter at its termination to facilitate efficient optical coupling with the fiber 160. The magnetic retention approach may also be used with grating couplers formed on the PIC 120, where the fiber 160 is positioned at an angle relative to the surface of the PIC 120 for vertical coupling. In some cases, the magnetic bars 128 may be oriented to position the FAU 150 at a predetermined angle suitable for grating coupler operation. The flexibility of the magnetic retention mechanism allows it to be adapted to various optical coupling configurations while providing the benefits of reduced mechanical wear and consistent attachment force over repeated connection cycles.

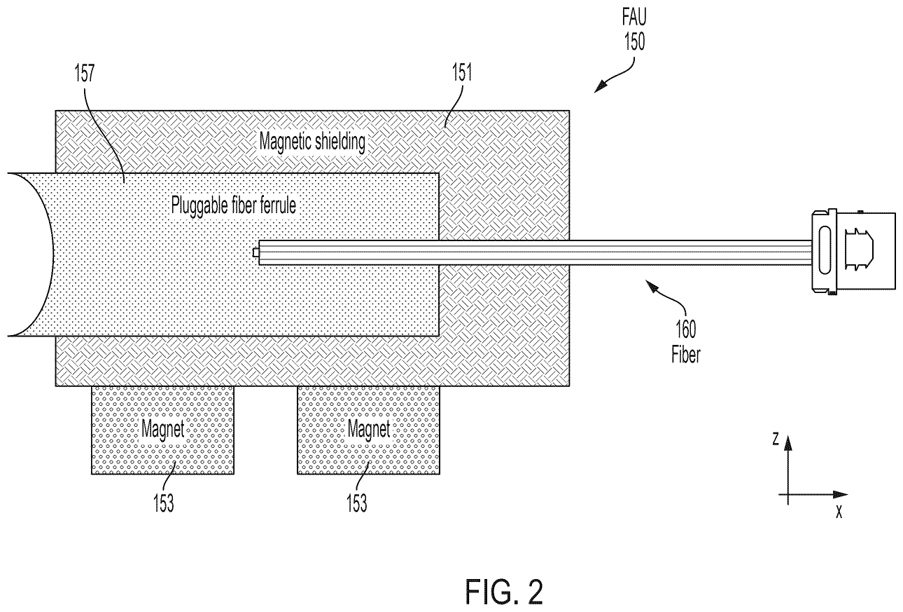

Referring to FIG. 2, a side view (along the xz plane) of an example of an FAU 150 illustrates the structural components that enable magnetic attachment to the substrate 100. The FAU 150 includes a pluggable fiber ferrule 157 that holds and aligns the fiber 160 for optical coupling. The pluggable fiber ferrule 157 may be made of glass material, which provides dimensional stability and optical transparency suitable for fiber alignment applications. In some cases, the pluggable fiber ferrule 157 may be fabricated from other materials such as ceramic or silicon, depending on the application requirements.

The pluggable fiber ferrule 157 is encased within a magnetic shielding 151 that surrounds the pluggable fiber ferrule 157. The magnetic shielding 151 forms a Faraday cage around the pluggable fiber ferrule 157 to protect the pluggable fiber ferrule 157 from electromagnetic interference. The Faraday cage configuration provided by the magnetic shielding 151 attenuates the electromagnetic field of magnets 153, which could otherwise interfere with optical signal transmission or affect sensitive components within the FAU 150. The magnetic shielding 151 may comprise copper, which provides effective electromagnetic shielding properties due to the high electrical conductivity of copper.

As further shown in FIG. 2, a pair of magnets 153 are attached beneath the magnetic shielding 151. The magnets 153 are positioned on a lower surface of the magnetic shielding 151 and are configured to align with the magnetic bars 128 disposed on the substrate 100 when the FAU 150 is inserted into the socket 152. The magnets 153 may comprise permanent magnets formed from ferromagnetic materials such as neodymium-iron-boron (NdFeB), samarium-cobalt (SmCo), or ferrite compositions. In some cases, the magnets 153 may comprise electromagnets that can be selectively energized to control the attachment force.

The magnets 153 are configured to magnetically couple with the magnetic bars 128 to secure the FAU 150 to the substrate 100. The magnetic coupling between the magnets 153 and the magnetic bars 128 occurs through magnetic attraction, where the magnetic field generated by the magnets 153 induces magnetization in the magnetic bars 128. The magnetic bars 128 may comprise a ferromagnetic material such as nickel, iron, or steel that exhibits high magnetic permeability, allowing the magnetic bars 128 to be attracted to the magnets 153. When the FAU 150 is brought into proximity with the magnetic bars 128, the magnetic field lines from the magnets 153 pass through the magnetic bars 128, creating an attractive force that draws the FAU 150 toward the magnetic bars 128 and holds the FAU 150 in position. The strength of the magnetic coupling may be determined by factors including the magnetic field strength of the magnets 153, the magnetic permeability of the magnetic bars 128, the distance between the magnets 153 and the magnetic bars 128, and the surface area of magnetic contact. The magnetic retention force may be configured to provide sufficient holding strength to maintain optical alignment between the fiber 160 and the waveguide 123 of the PIC 120 while allowing the FAU 150 to be removed by applying a separation force that overcomes the magnetic attraction.

Referring to FIGS. 3A-3B, an example of a socket 152 is shown in orthogonal views that illustrate a potential structural configuration. FIG. 3A shows a side view of the socket 152 along the xz plane, while FIG. 3B shows a view of the socket 152 along the yz plane. The socket 152 is disposed on the substrate 100 and is configured to receive the FAU 150 for magnetic attachment to the device 10.

The socket 152 is formed from a non-magnetic material. The non-magnetic material may comprise aluminum, which provides structural rigidity while avoiding interference with the magnetic retention mechanism used to secure the FAU 150 to the substrate 100. In some cases, the socket 152 may be formed from other non-magnetic materials such as plastic, ceramic, or non-magnetic metals. The use of a non-magnetic material for the socket 152 allows the magnetic field from the magnets 153 on the FAU 150 to pass through the socket 152 without attenuation, enabling effective magnetic coupling between the magnets 153 and the magnetic bars 128.

As shown in FIGS. 3A-3B, the socket 152 includes a cutout 154 that provides an opening for insertion of the FAU 150. The cutout 154 is positioned in a lower portion of the socket 152 and extends through the socket 152 to allow the pluggable fiber ferrule 157 of the FAU 150 to pass through and attach to the magnetic bars 128 positioned beneath the socket 152. The FAU 150 is disposed in the cutout 154 when the FAU 150 is inserted into the socket 152 and magnetically coupled to the magnetic bars 128. The cutout 154 may be sized to accommodate the FAU 150 while providing clearance for insertion and removal of the FAU 150.

In this implementation, the socket 152 exhibits an L-shaped profile when viewed from the side in FIG. 3A, with the cutout 154 located at a junction of the vertical and horizontal portions of the socket 152. However, other shapes are possible. In FIG. 3B, the socket 152 appears as a rectangular structure with the cutout 154 centrally positioned. A bottom edge of the socket 152 in both views shows tapered features 155 that correspond to locations of the magnetic bars 128, allowing the socket 152 to be positioned around the magnetic bars 128 during assembly.

Referring back to FIG. 1, the socket 152 extends over a portion of the coupler 140 that optically couples the waveguide 123 to the fiber 160. The socket 152 acts as a cover for the coupler 140, providing protection for the coupler 140 from environmental contaminants, physical damage, and other external factors that could affect optical performance. The protective function of the socket 152 may help maintain optical coupling efficiency between the fiber 160 and the waveguide 123 over the operational lifetime of the device 10.

Referring to FIG. 4, a sectional view of an example of a coupler illustrates optical elements that may enable light transmission between the waveguide 123 and the fiber 160. The coupler 140 comprises a plurality of reflective surfaces configured to guide light between the waveguide 123 and the fiber 160. The plurality of reflective surfaces includes a reflective surface 141, a reflective surface 142, and a reflective surface 143. The coupler 140 further comprises a lens 144 configured to focus or collimate light reflected by the plurality of reflective surfaces.

Light paths traveling through the coupler 140 are reflected between the reflective surface 141, the reflective surface 142, and the reflective surface 143 before passing through the lens 144. The shapes of the reflective surface 141, the reflective surface 142, and the reflective surface 143 are engineered to control lateral extension of a free space mode as the free space mode propagates within the coupler 140. The reflective surface 141 and the reflective surface 143 may be curved in a manner that expands a mode size from a mode of the waveguide 123 to a mode of the fiber 160. This mode size expansion facilitates efficient optical coupling between the waveguide 123, which may have a smaller mode field diameter, and the fiber 160, which may have a larger mode field diameter. The curvature of the reflective surface 141 and the reflective surface 143 may be designed to gradually expand the optical beam as the optical beam propagates through the coupler 140, reducing coupling losses that could otherwise occur due to mode mismatch between the waveguide 123 and the fiber 160.

The lens 144 may provide additional control over the optical beam characteristics as light enters or exits the coupler 140. In some cases, the lens 144 may collimate light reflected by the plurality of reflective surfaces to produce a parallel beam suitable for transmission through free space or into the fiber 160. In some cases, the lens 144 may focus light reflected by the plurality of reflective surfaces to concentrate the optical beam at a focal point corresponding to an end facet of the fiber 160 or an input of the waveguide 123. The lens 144 may be integrated as part of the coupler 140 structure or may be a separate optical element attached to the coupler 140.

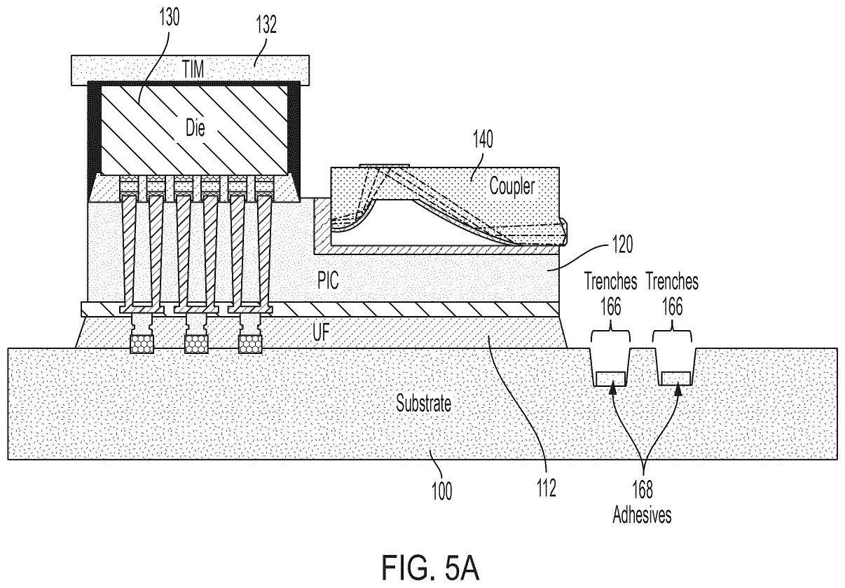

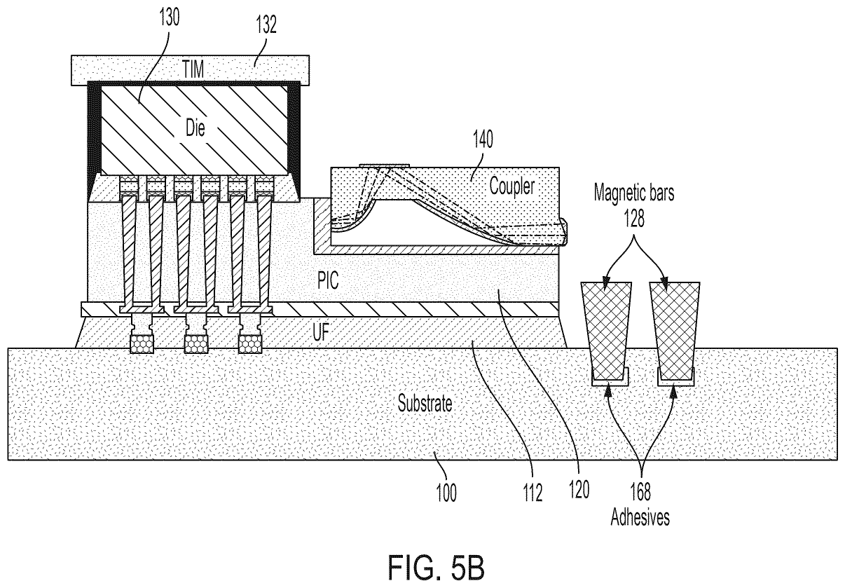

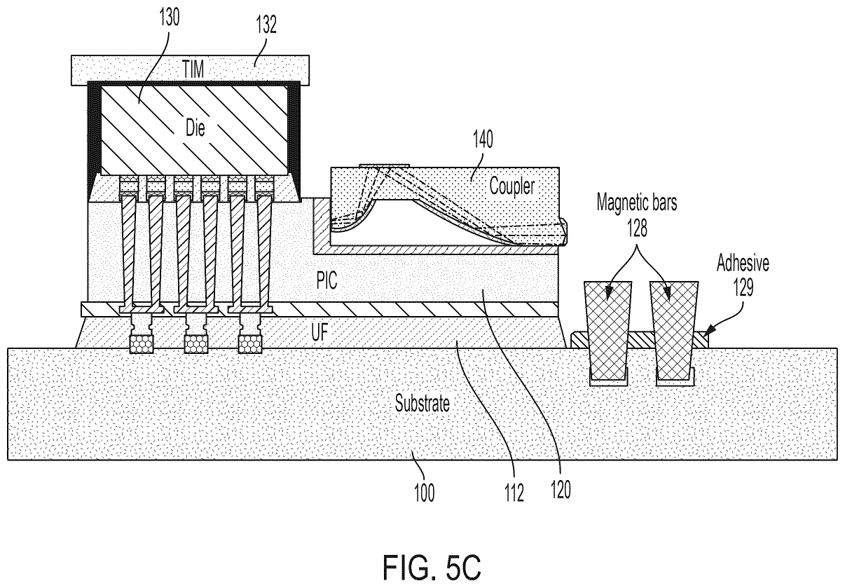

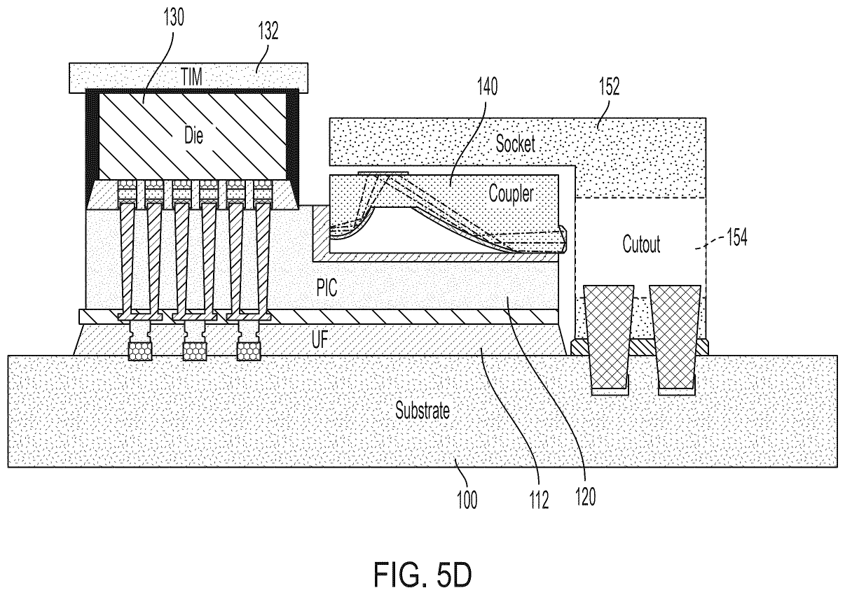

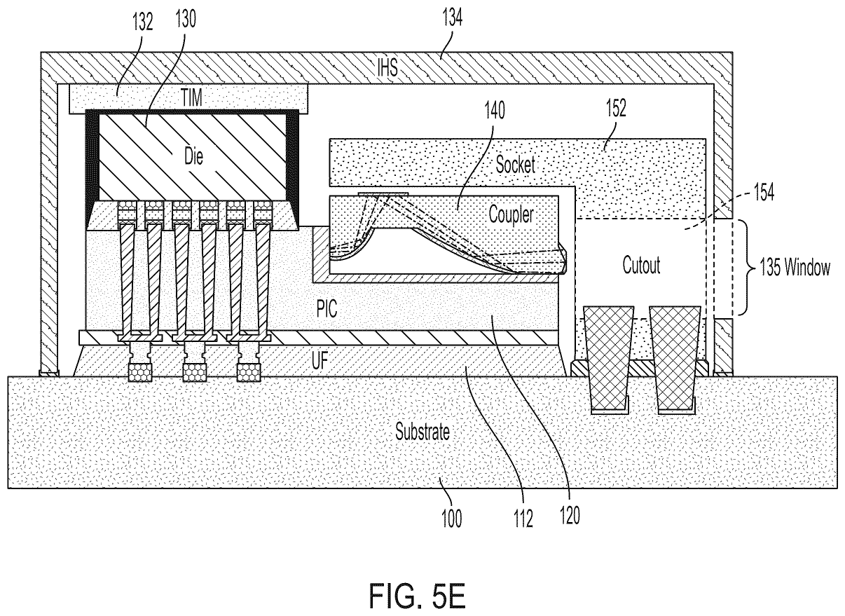

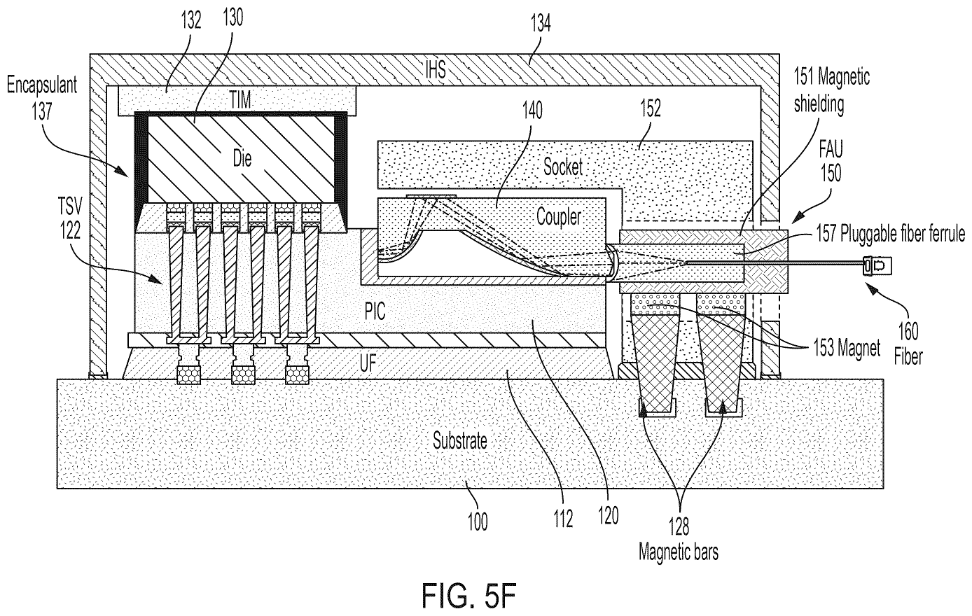

FIGS. 5A-5F illustrate a process flow for manufacturing a device, according to some embodiments. The process flow describes a method of manufacturing an optical device that includes a magnetically attachable FAU.

Referring to FIG. 5A, an initial step of the manufacturing process is shown. The method includes providing the substrate 100. The PIC 120 is disposed on the substrate 100. The underfill 112 is positioned between the substrate 100 and the PIC 120. The die 130 is positioned above the PIC 120, with the TIM 132 disposed on top of the die 130. The coupler 140 is attached to the PIC 120 and extends laterally from the die 130.

As shown in FIG. 5A, trenches 166 are formed in an upper surface of the substrate 100. The trenches 166 are positioned adjacent to the coupler 140 and are configured to receive the magnetic bars 128 in a subsequent step of the manufacturing process. The trenches 166 may be formed by machining, etching, or other suitable material removal techniques. The trenches 166 may be sized to accommodate the magnetic bars 128 with sufficient clearance for insertion while providing lateral constraint to position the magnetic bars 128 in alignment with the magnets on the FAU 150.

Adhesives 168 are dispensed in the trenches 166 prior to attaching the magnetic bars 128. As shown in FIG. 5A, the adhesives 168 are disposed at bottom surfaces of the trenches 166. The adhesives 168 may comprise an epoxy, a cyanoacrylate, or other suitable bonding material configured to secure the magnetic bars 128 within the trenches 166. The adhesives 168 provide mechanical attachment between the magnetic bars 128 and the substrate 100, maintaining the position of the magnetic bars 128 during subsequent assembly steps and during operation of the device 10. The adhesives 168 may be dispensed using automated dispensing equipment that deposits a controlled volume of adhesive material at predetermined locations within the trenches 166.

Referring to FIG. 5B, a subsequent step of the manufacturing process is shown in which the magnetic bars 128 are attached in the trenches 166 formed in the substrate 100. The magnetic bars 128 are disposed in the trenches and secured with the adhesives 168 that were dispensed in the previous step. The magnetic bars 128 extend vertically from the trenches and are positioned adjacent to the coupler 140.

The magnetic bars 128 may be formed from nickel, which is a magnetic metal suitable for magnetic coupling with the magnets attached to the FAU 150. Nickel exhibits ferromagnetic properties that enable the magnetic bars 128 to be attracted to the magnets 153 on the FAU 150 when the FAU 150 is brought into proximity with the magnetic bars 128.

The magnetic bars 128 are inserted into the trenches in the substrate 100 to provide alignment of the pluggable FAU 150 during attachment. When the FAU 150 is inserted through the socket 152, the magnets 153 on the FAU 150 are drawn toward the magnetic bars 128 through magnetic attraction. The positioning of the magnetic bars 128 within the trenches guides the FAU 150 into a predetermined alignment position, where the fiber 160 is positioned for optical coupling with the waveguide 123 of the PIC 120. The lateral constraint provided by the trenches maintains the position of the magnetic bars 128, which in turn maintains the alignment of the FAU 150 relative to the coupler 140 and the waveguide 123.

Referring to FIG. 5C, a subsequent step of the manufacturing process is shown in which an adhesive 129 is disposed between and around the magnetic bars 128. The adhesive 129 secures the magnetic bars 128 within the trenches and maintains the position of the magnetic bars 128 during subsequent assembly steps and during operation of the device 10. The adhesive 129 may comprise an epoxy, a cyanoacrylate, or other suitable bonding material that provides mechanical attachment between the magnetic bars 128 and the substrate 100.

The adhesive 129 is visible at the base of the magnetic bars 128 where the magnetic bars 128 contact the bottom surfaces of the trenches. The adhesive 129 fills the space between the magnetic bars 128, providing a bonding interface that resists displacement of the magnetic bars 128 when the FAU 150 is attached or removed from the device 10. The adhesive 129 may be cured using thermal energy, ultraviolet light, or other suitable curing mechanisms depending on the composition of the adhesive 129.

Referring to FIG. 5D, a subsequent step of the manufacturing process is shown in which a socket 152 is attached to the substrate 100. The method includes attaching the socket 152 to the substrate 100, where the socket 152 has a cutout 154 configured to receive a fiber array unit (FAU). The socket 152 is positioned on the substrate 100 such that the cutout 154 is aligned with the magnetic bars that were attached in the previous step of the manufacturing process.

The socket 152 is attached to adhesive 129 that was dispensed on the substrate 100 around the magnetic bars in a prior step. The adhesive 129 provides a bonding interface between the socket 152 and the substrate 100, securing the socket 152 in position during subsequent assembly steps and during operation of the device. The socket 152 may be pressed onto the adhesive and held in place while the adhesive cures to form a permanent bond.

The cutout 154 of the socket 152 provides an opening through which the FAU can be inserted and magnetically attached to the magnetic bars disposed in the substrate 100. The cutout 154 is dimensioned to accommodate the FAU while providing clearance for insertion and removal of the FAU. The positioning of the socket 152 relative to the magnetic bars aligns the cutout 154 such that the FAU, when inserted through the cutout 154, is guided toward the magnetic bars for magnetic coupling. The socket 152 extends over a portion of the coupler 140 that is attached to the PIC 120. This arrangement allows the socket 152 to serve as a protective cover for the coupler 140.

Referring to FIG. 5E, a subsequent step of the manufacturing process is shown in which the IHS 134 is attached to the substrate 100. The method includes attaching the IHS 134 to the substrate 100 such that the IHS 134 contacts the TIM 132 disposed on the die 130 positioned above the PIC 120. The IHS 134 provides thermal management for the device by dissipating heat generated by the die 130 during operation. The contact between the IHS 134 and the TIM 132 establishes a thermally conductive pathway that transfers heat from the die 130 through the TIM 132 to the IHS 134, where the heat can be dissipated to the surrounding environment.

As shown in FIG. 5E, the IHS 134 includes a window 135 that provides an opening for optical access. The window 135 is positioned in the IHS 134 to allow light to pass through the IHS 134 without obstruction. The window 135 may be aligned with cutout 154 to enable optical signals to be transmitted between the fiber 160 and the waveguide 123 of the PIC 120 when the FAU 150 is attached to the device. The window 135 may comprise an aperture formed in the IHS 134, or the window 135 may comprise a transparent material that is optically transmissive at wavelengths used for optical communication.

The IHS 134 may be attached to the substrate 100 using an adhesive, a mechanical fastener, or other suitable attachment mechanism. The IHS 134 may be formed from a thermally conductive material such as copper, aluminum, or a copper-aluminum composite that provides efficient heat spreading and dissipation. The IHS 134 may include fins, channels, or other surface features that increase the surface area available for heat dissipation. In some cases, the IHS 134 may be configured to interface with an external heat sink or cooling system to further enhance thermal management of the device.

Referring to FIG. 5F, a subsequent step of the manufacturing process is shown in which the FAU 150 is inserted through the cutout of the socket 152. The method includes inserting the FAU through the cutout, where the FAU comprises a magnet configured to magnetically couple with the magnetic bar to secure the FAU to the substrate. The FAU 150 passes through the window 135 of the IHS 134 and through the cutout 154 of the socket 152 to reach the magnetic bars 128 disposed in the substrate 100.

As shown in FIG. 2, the FAU 150 may comprise a pluggable fiber ferrule encased within a magnetic shielding. The pluggable fiber ferrule holds and aligns the fiber 160 for optical coupling with the coupler 140 and the waveguide 123 of the PIC 120. The magnetic shielding surrounds the pluggable fiber ferrule and forms a Faraday cage that provides electromagnetic protection for the optical components contained within the FAU 150.

The magnet is attached beneath the magnetic shielding of the FAU 150. When the FAU 150 is inserted through the cutout of the socket 152, the magnet on the FAU 150 is brought into proximity with the magnetic bars 128. The magnet is configured to magnetically couple with the magnetic bars 128 through magnetic attraction, drawing the FAU 150 toward the magnetic bars 128 and securing the FAU 150 to the substrate 100. The magnetic coupling between the magnet and the magnetic bars 128 provides retention force that maintains the position of the FAU 150 relative to the coupler 140 and the waveguide 123 of the PIC 120.

The insertion of the FAU 150 through the cutout of the socket 152 aligns the fiber 160 with the coupler 140 for optical coupling. The magnetic bars 128, which are disposed in trenches formed in the substrate 100, guide the FAU 150 into a predetermined alignment position as the magnet on the FAU 150 is attracted to the magnetic bars 128. Once the FAU 150 is magnetically attached to the substrate 100, the fiber 160 is optically coupled to the waveguide 123 of the PIC 120 through the coupler 140, completing the optical connection between the device and external optical systems.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure. Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

What is claimed is:

1. A device, comprising:
a substrate;
a photonic integrated circuit (PIC) disposed on the substrate; and
a magnetic bar disposed on the substrate, wherein the magnetic bar is configured to magnetically couple to a magnet of a fiber array unit (FAU).

2. The device of claim 1, further comprising a socket disposed on the substrate, the socket having a cutout in which the FAU is disposed.

3. The device of claim 2, wherein the socket is formed from a non-magnetic material.

4. The device of claim 1, further comprising the FAU and a fiber attached to the FAU, wherein the fiber is configured to be optically coupled to a waveguide of the PIC when the magnetic bar is magnetically coupled to the magnet.

5. The device of claim 4, further comprising a coupler configured to optically couple the waveguide to the fiber.

6. The device of claim 5, wherein the coupler comprises a plurality of reflective surfaces configured to guide light between the waveguide and the fiber.

7. The device of claim 6, wherein the coupler further comprises a lens configured to focus or collimate light reflected by the plurality of reflective surfaces.

8. The device of claim 4, wherein the FAU comprises:
a pluggable fiber ferrule holding the fiber; and
magnetic shielding encasing the pluggable fiber ferrule, wherein the magnet is attached to the magnetic shielding.

9. The device of claim 8, wherein the magnetic shielding comprises copper.

10. The device of claim 1, wherein the magnetic bar is disposed in a trench formed in the substrate.

11. The device of claim 10, further comprising an adhesive disposed between the magnetic bar and a bottom of the trench.

12. A device, comprising:
a substrate;
a photonic integrated circuit (PIC) disposed on the substrate, the PIC having a waveguide; and
a fiber array unit (FAU) to which a fiber is attached, wherein the FAU is magnetically attached to the substrate, and wherein the fiber is optically coupled to the waveguide of the PIC.

13. The device of claim 12, further comprising a magnetic bar disposed on the substrate and a magnet attached to the FAU, wherein the magnet is configured to magnetically couple with the magnetic bar to secure the FAU to the substrate.

14. The device of claim 13, wherein the magnetic bar is disposed in a trench formed in the substrate.

15. The device of claim 14, further comprising an adhesive disposed between the magnetic bar and a bottom of the trench.

16. The device of claim 12, further comprising a socket disposed on the substrate, the socket having a cutout in which the FAU is disposed, wherein the socket extends over a portion of a coupler that optically couples the waveguide to the fiber.

17. A method of manufacturing an optical device, comprising:
providing a substrate having a trench formed therein, wherein a photonic integrated circuit (PIC) is disposed on the substrate;
attaching a magnetic bar in the trench;
attaching a socket to the substrate, the socket having a cutout configured to receive a fiber array unit (FAU) to which a fiber is attached; and
inserting the FAU through the cutout to optically couple the PIC to the fiber, wherein the FAU comprises a magnet configured to magnetically couple with the magnetic bar to secure the FAU to the substrate.

18. The method of claim 17, further comprising dispensing adhesive on the substrate around the magnetic bar prior to attaching the socket.

19. The method of claim 17, further comprising attaching an integrated heat spreader (IHS) to the substrate such that the IHS contacts a thermal interface material (TIM) disposed on a die positioned above the PIC.

20. The method of claim 17, wherein the FAU comprises a pluggable fiber ferrule encased within a magnetic shielding, and wherein the magnet is attached beneath the magnetic shielding.
